(19) United States
(12) Patent Application Publication
(10) Pub. No.: US 2024/0257134 A1
(43) Pub. Date: Aug. 1, 2024

(54) SYSTEMS AND METHODS FOR INTELLIGENT THREAT DETECTION AND PREVENTION IN POINT-OF-SALE TERMINALS

(71) Applicant: JPMORGAN CHASE BANK, N.A., New York, NY (US)

(72) Inventor: Bharathan KASTHURIRENGAN, Rutherford, NJ (US)

(21) Appl. No.: 18/162,828

(22) Filed: Feb. 1, 2023

(51) Int. Cl. G06Q 20/40; G06Q 20/32

(52) U.S. Cl. CPC G06Q 20/4016; G06Q 20/3224; G06Q 20/4093

(57) ABSTRACT

Systems and methods for intelligent threat detection and prevention in point-of-sale terminals are disclosed. According to an embodiment, a method for intelligent threat detection and prevention in point-of-sale terminals may include: (1) receiving, by a backend computer program and from a threat collector agent executed on a point-of-sale terminal for a merchant, merchant behavioral activity involving a payment application executed by the point-of-sale terminal that was captured by the threat collector agent; (2) identifying, by the backend computer program, fraud or a threat from the merchant behavioral activity by providing the merchant behavioral activity to a trained merchant behavioral threat modeler; and (3) executing, by the backend computer program, a preventative action in response to the identified fraud or threat.

### BACKGROUND OF THE INVENTION

### 1. Field of the Invention

Embodiments generally relate to systems and methods for intelligent threat detection and prevention in point-of-sale terminals.

### 2. Description of the Related Art

Point-of-sale terminals, including smart terminals and bring your own device (BYOD) terminals are often used by small to medium merchants to process and accept payments for card present and card not present situations. Most point-of-sale terminals have limits on how long a user active session may last to provide a better user experience and may also provide the ability to switch merchant accounts (e.g., sub user, multiple merchant profile, etc.) to address ease of ease.

Acquiring platforms may provide security controls, such as merchant profiling, geofencing, transaction monitoring, etc. to detect and prevent fraud. Most of the security controls are, however, in the trusted network and not at the edge (e.g., at the point-of-sale terminal). Given these constraints, current threat modelling is often built on the user persona and not on the terminals/device personas.

### SUMMARY OF THE INVENTION

Systems and methods for intelligent threat detection and prevention in point-of-sale terminals are disclosed. According to an embodiment, a method for intelligent threat detection and prevention in point-of-sale terminals may include: (1) receiving, by a backend computer program and from a threat collector agent executed on a point-of-sale terminal for a merchant, merchant behavioral activity involving a payment application executed by the point-of-sale terminal that was captured by the threat collector agent; (2) identifying, by the backend computer program, fraud or a threat from the merchant behavioral activity by providing the merchant behavioral activity to a trained merchant behavioral threat modeler; and (3) executing, by the backend computer program, a preventative action in response to the identified fraud or threat.

In one embodiment, the merchant behavioral activity may include a login time to the payment application and a merchant login account.

In one embodiment, the merchant behavioral activity may include a geolocation of the point-of-sale terminal and/or an online/offline status for the point-of-sale terminal.

In one embodiment, the merchant behavioral activity may include a timing of a transaction authorization request and/or response to the transaction authorization request.

In one embodiment, the preventative action may be based on a merchant profile or a merchant risk category for the merchant.

In one embodiment, the trained merchant behavioral threat modeler may be trained on prior merchant behavior and/or terminal configuration behavior.

In one embodiment, the preventative action may include requiring out-of-band authentication from the merchant.

In one embodiment, the preventative action may include sending a signal to the payment application that logs the merchant out of the payment application.

In one embodiment, the preventative action may include rejecting a transaction authorization request.

According to another embodiment, a system may include a point-of-sale terminal for a merchant executing a payment application and a threat collector agent computer program, wherein the threat collector agent computer program captures merchant behavioral activity involving the payment application; and an electronic device executing a backend computer program that receives the merchant behavioral activity from the threat collector agent computer program, identifies fraud or a threat from the merchant behavioral activity by providing the merchant behavioral activity to a trained merchant behavioral threat modeler, and executes a preventative action in response to the identified fraud or threat.

In one embodiment, the merchant behavioral activity may include a login time to the payment application and a merchant login account.

In one embodiment, the merchant behavioral activity may include a geolocation of the point-of-sale terminal and/or an online/offline status for the point-of-sale terminal.

In one embodiment, the merchant behavioral activity may include a timing of a transaction authorization request and/or response to the transaction authorization request.

In one embodiment, the preventative action may be based on a merchant profile or a merchant risk category for the merchant.

In one embodiment, the trained merchant behavioral threat modeler may be trained on prior merchant behavior and/or terminal configuration behavior.

In one embodiment, the preventative action may include requiring out-of-band authentication from the merchant.

In one embodiment, the preventative action may include sending a signal to the payment application that logs the merchant out of the payment application.

In one embodiment, the preventative action may include rejecting a transaction authorization request.

According to another embodiment, a non-transitory computer readable storage medium, may include instructions stored thereon, which when read and executed by one or more computer processors, cause the one or more computer processors to perform steps comprising: receiving, from a threat collector agent executed on a point-of-sale terminal for a merchant, merchant behavioral activity involving a payment application executed by the point-of-sale terminal that was captured by the threat collector agent, wherein the merchant behavioral activity comprises a login time to the payment application, a merchant login account, a geolocation of the point-of-sale terminal, an online/offline status for the point-of-sale terminal, a timing of a transaction authorization request and/or response to the transaction authorization request; identifying fraud or a threat from the merchant behavioral activity by providing the merchant behavioral activity to a trained merchant behavioral threat modeler, wherein the trained merchant behavioral threat modeler is trained on prior merchant behavior and/or terminal configuration behavior; and executing a preventative action in response to the identified fraud or threat, wherein the preventative action is based on a merchant profile or a merchant risk category for the merchant.

In one embodiment, the preventative action may include requiring out-of-band authentication from the merchant, sending a signal to the payment application that logs the merchant out of the payment application, or rejecting a transaction authorization request.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for intelligent threat detection and prevention in point-of-sale terminals according to an embodiment;

FIG. 2 illustrates a method for intelligent threat detection and prevention in point-of-sale terminals according to an embodiment;

FIG. 3 depicts an exemplary computing system for implementing aspects of the present disclosure.

### DETAILED DESCRIPTION OF PREFERRED EMBODIMENTS

Embodiments are directed to systems and methods for intelligent threat detection and prevention in point-of-sale terminals.

Embodiments may leverage sophisticated security controls at the edge (e.g., at the point-of-sale terminal) and may monitor merchant behavior, such as login time, inactive session, sales, refunds, switches of user accounts, tracking location of devices, etc. to detect malicious attacks and provide notifications based on detected patterns. Embodiments may lock merchant account(s), may deactivate the point-of-sale terminal, etc.

Embodiments may leverage a set of data to monitor user behavior. For example, an agent installed on the point-of-sale terminal may continuously collect data from payment application, devices, internet traffic, and other sources using, for example, a persistent connection to backend application programming instances (APIs).

The backend APIs receive the data stream and, instead of leveraging batch analytics, may use a stateful set of consumer behavioral data and may aggregate, filter, and transform the data to a specific format. Next, the backend may apply machine learning models, such as contextual reinforcement learning models, to the aggregated data over time to generate key metrics against baselined standard consumer behavioral patterns and may derive potential fraud/threats in real time.

Once identified, the backend may apply a set of rules to determine whether to take a preventive action, such as terminal deactivation, merchant lockout, alerts to merchant, etc. In one embodiment, the rules may be set by an operations team or similar, may be based on machine learning, etc.

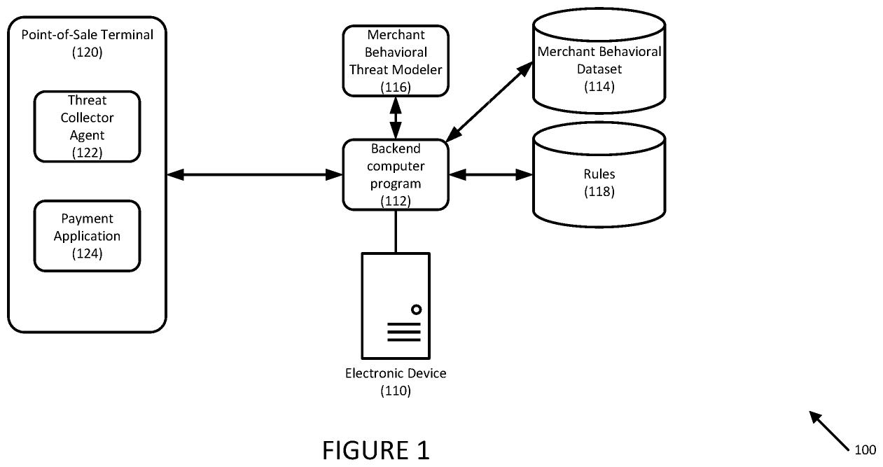

Referring to FIG. 1, a system for intelligent threat detection and prevention in point-of-sale terminals is disclosed according to an embodiment. System 100 may include electronic device 110, such as a server (e.g., physical and/or cloud-based), a computer (e.g., workstation, desktop, notebook, tablet, etc.), Internet of Things (IoT) appliance, etc. that may execute backend computer program 112. Backend computer program 112 may receive terminal data for point-of-sale terminal 120, such as login time, location (e.g., latitude and longitude, GPS location, etc.), configuration information, merchant account information, etc. as well as terminal activity data (e.g., sales, refunds, declines, account switches, etc.) from point-of-sale terminal 120.

Point-of-sale terminal 120 may be any suitable device, including dedicated point-of-sale terminals, computers (e.g., tablet computer) executing a payment application, kiosks, etc. Point-of-sale terminal 120 may execute a plurality of computer applications, including threat collector agent 122, payment application 124, etc. Threat collector agent 122 may be a program, application, script, etc. executed by point-of-sale terminal 120 that may collect the terminal data and the terminal activity data and may communicate the data to backend computer program 112. For example, threat collector agent 122 may monitor activities involving payment application 124, such as merchant logins to payment application 124, results of payment authorizations submitted by payment application 124, etc.

Payment application 124 may be a program, application, script, etc. executed by point-of-sale terminal 120 that may interface with a payment gateway (not shown) for a financial institution. Payment application 124 may capture payment information for a transaction.

In one embodiment, the connection between point-of-sale terminal 120 and backend computer program 112 may be a persistent connection. Threat collector agent 122 may send packets of data over the persistent connection to backend computer program 112.

Backend computer program 112 may process the data received from threat collector agent 122 and may generate merchant behavioral dataset 114. In one embodiment, a separate merchant behavioral dataset 114 may be maintained for each merchant, each merchant account, etc. In another embodiment, similar merchants may have their data maintained in a common merchant behavioral dataset 114.

Backend computer program 112 may further train merchant behavioral threat modeler 116, which may be trained using machine learning models (e.g., such as contextual reinforcement learning models) to identify merchant behaviors.

Backend computer program 112 may use real-time threat controls using, for example, receive rules from rules database 118. The rules may identify preventative actions for backend computer program 112 to take in response to a threat or fraud. Examples of preventative action may include terminal deactivation, merchant lockout, merchant alerts, etc.

In one embodiment, the connection between point-of-sale terminal 120 and backend computer program 112 may be a persistent connection. Threat collector agent 122 may send packets of data over the persistent connection to backend computer program 112.

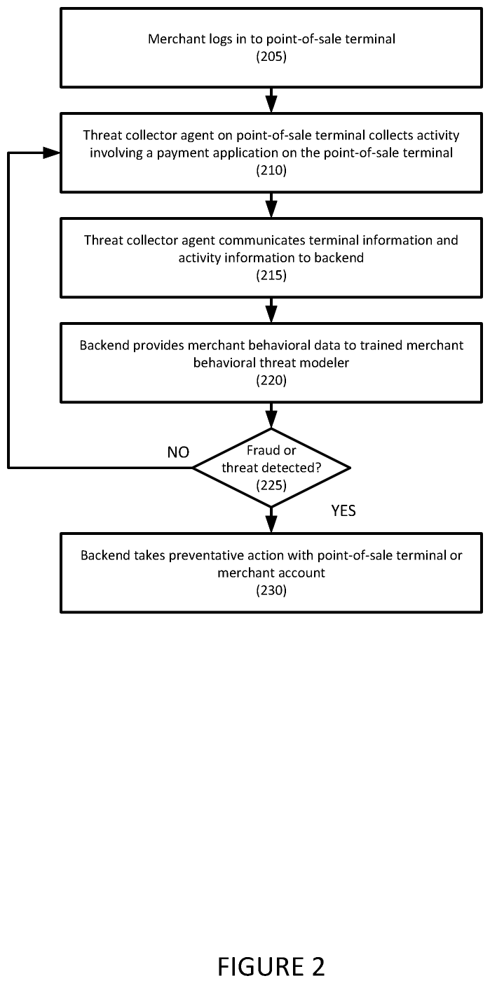

Referring to FIG. 2, a method for intelligent threat detection and prevention in point-of-sale terminals is disclosed according to an embodiment.

In step 205, a merchant logs into a point-of-sale terminal. In one embodiment, the merchant may enter merchant account login information (e.g., username and password) and may log in a payment application executed by the point-of-sale terminal.

In step 210, a threat collector agent executed by the point-of-sale terminal may collect merchant behavioral activity with a payment application and/or point-of-sale terminal, including for example login time, terminal location, merchant account information, etc. and may send the information to a backend. For example, the threat collector agent may monitor the payment application and may collect data involving the payment application, such as login information, account changes, timing and/or statuses of transaction authorization request messages and responses, etc. It may also receive geolocation data from, for example, a location sensor in the point-of-sale terminal. The geolocation information may be captured periodically, upon start-up, when accounts change, etc.

In step 215, the threat collector agent may communicate the merchant behavioral activity and/or terminal information to the backend. In one embodiment, the threat collector agent may communicate the activity type, the activity time, a terminal identifier, online/offline status, geolocation, etc. to the backend.

In one embodiment, the merchant behavioral activity may be transmitted as it occurs, periodically, etc. The merchant behavioral activity may also be transmitted individually or in bulk. In one embodiment, the threat collector agent may communicate small packets to the backend over a persistent connection.

In step 220, a computer program executed by the backend may provide the merchant behavioral activity to a trained merchant behavioral threat modeler to determine whether there is fraud or a threat. For example, the behavioral threat modeler may be trained on prior merchant behavior (e.g., weekday behavior, weekend behavior, peak time behavior, off season behavior, primary user behavior, sub-user behavior, etc.), terminal configuration behavior, mode (offline/online) behavior, etc.

If, in step 225, fraud or a threat is detected, in step 230, the backend computer program may take a preventative action with the terminal (e.g., additional authentication, deactivation, etc.) or with the merchant account (e.g., merchant lockout, alerts). The preventative action may be based on, for example, a merchant profile and/or risk category for the merchant. The preventative actions may include soft and hard actions that may be taken by the backend, including issuing a warning, temporary suspending the merchant account suspension, rejecting a transaction, requiring out-of-band authentication, forcing logout from the payment application, etc. For example, the backend may require that the merchant login to the terminal again, may require that the merchant provide out-of-band authentication, may refuse communications from the terminal, may send a signal to the terminal that causes the terminal to log out of the merchant account, may disable the terminal (e.g., erase keys), etc. The backend computer program may also notify the merchant of the fraud or threat.

If there is no fraud, the process may return to step 215. Thus, there is no impact to any transactions.

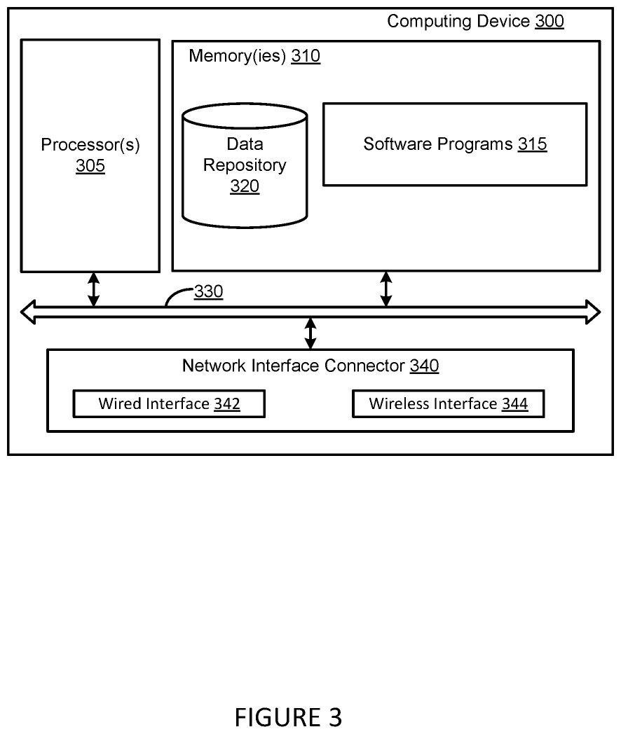

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for intelligent threat detection and prevention in point-of-sale terminals, comprising:
receiving, by a backend computer program and from a threat collector agent executed on a point-of-sale terminal for a merchant, merchant behavioral activity involving a payment application executed by the point-of-sale terminal that was captured by the threat collector agent;
identifying, by the backend computer program, fraud or a threat from the merchant behavioral activity by providing the merchant behavioral activity to a trained merchant behavioral threat modeler; and
executing, by the backend computer program, a preventative action in response to the identified fraud or threat.

2. The method of claim 1, wherein the merchant behavioral activity comprises a login time to the payment application and a merchant login account.

3. The method of claim 1, wherein the merchant behavioral activity comprises a geolocation of the point-of-sale terminal and/or an online/offline status for the point-of-sale terminal.

4. The method of claim 1, wherein the merchant behavioral activity comprises a timing of a transaction authorization request and/or response to the transaction authorization request.

5. The method of claim 1, wherein the preventative action is based on a merchant profile or a merchant risk category for the merchant.

6. The method of claim 1, wherein the trained merchant behavioral threat modeler is trained on prior merchant behavior and/or terminal configuration behavior.

7. The method of claim 1, wherein the preventative action comprises requiring out-of-band authentication from the merchant.

8. The method of claim 1, wherein the preventative action comprises sending a signal to the payment application that logs the merchant out of the payment application.

9. The method of claim 1, wherein the preventative action comprises rejecting a transaction authorization request.

10. A system, comprising:
a point-of-sale terminal for a merchant executing a payment application and a threat collector agent computer program, wherein the threat collector agent computer program captures merchant behavioral activity involving the payment application; and
an electronic device executing a backend computer program that receives the merchant behavioral activity from the threat collector agent computer program, identifies fraud or a threat from the merchant behavioral activity by providing the merchant behavioral activity to a trained merchant behavioral threat modeler, and executes a preventative action in response to the identified fraud or threat.

11. The system of claim 10, wherein the merchant behavioral activity comprises a login time to the payment application and a merchant login account.

12. The system of claim 10, wherein the merchant behavioral activity comprises a geolocation of the point-of-sale terminal and/or an online/offline status for the point-of-sale terminal.

13. The system of claim 10, wherein the merchant behavioral activity comprises a timing of a transaction authorization request and/or response to the transaction authorization request.

14. The system of claim 10, wherein the preventative action is based on a merchant profile or a merchant risk category for the merchant.

15. The system of claim 10, wherein the trained merchant behavioral threat modeler is trained on prior merchant behavior and/or terminal configuration behavior.

16. The system of claim 10, wherein the preventative action comprises requiring out-of-band authentication from the merchant.

17. The system of claim 10, wherein the preventative action comprises sending a signal to the payment application that logs the merchant out of the payment application.

18. The system of claim 10, wherein the preventative action comprises rejecting a transaction authorization request.

19. A non-transitory computer readable storage medium, including instructions stored thereon, which when read and executed by one or more computer processors, cause the one or more computer processors to perform steps comprising:
receiving, from a threat collector agent executed on a point-of-sale terminal for a merchant, merchant behavioral activity involving a payment application executed by the point-of-sale terminal that was captured by the threat collector agent, wherein the merchant behavioral activity comprises a login time to the payment application, a merchant login account, a geolocation of the point-of-sale terminal, an online/offline status for the point-of-sale terminal, a timing of a transaction authorization request and/or response to the transaction authorization request;
identifying fraud or a threat from the merchant behavioral activity by providing the merchant behavioral activity to a trained merchant behavioral threat modeler, wherein the trained merchant behavioral threat modeler is trained on prior merchant behavior and/or terminal configuration behavior; and
executing a preventative action in response to the identified fraud or threat, wherein the preventative action is based on a merchant profile or a merchant risk category for the merchant.

20. The non-transitory computer readable storage medium of claim 19, wherein the preventative action comprises requiring out-of-band authentication from the merchant, sending a signal to the payment application that logs the merchant out of the payment application, or rejecting a transaction authorization request.
